(19) United States
(12) Patent Application Publication
(10) Pub. No.: US 2003/0085603 A1
(43) Pub. Date: May 8, 2003

(54) Seat reclining device for vehicle

(76) Inventors: Won Young Lee, Kyungju-Shi (KR); Jae Won Cha, Kyungju-Shi (KR)

Correspondence Address: JACOBSON HOLMAN PLLC, 400 Seventh Street, N. W., Washington, DC, 20004-2218, US

(21) Appl. No.: 10/247,829

(22) Filed: Sep. 20, 2002

(30) Foreign Application Priority Data
Nov. 8, 2001 (KR) 2001-69366

(51) Int. Cl. B60N 2/235

(52) U.S. Cl. 297/367

(57) ABSTRACT

Disclosed is a seat reclining device for a vehicle, including a plate holder fastened to a seat cushion frame, a toothed bracket fastened to a seat back frame and formed with first teeth, an operating section interposed between the plate holder and toothed bracket and having a pair of operating members and a cam lever, and a manipulating section having a shaft, a manipulating lever, a lever spring and a return spring, the operating members being formed with second teeth such that the second teeth can be meshed with and separated from the first teeth to permit and prevent reclining of a seat back and with a pair of cam grooves and a pair of cam lines, the cam lever being coupled to the shaft and formed with a pair of cams which function to move the operating members such that the second teeth are meshed with the first teeth. The device comprises means for separating the second teeth from the first teeth, the means including a pair of arm portions which are formed by inwardly extending one ends of inner surface portions of the operating members, a pair of engaging shoulders which are formed on free end portions of radial inner surfaces of the arm portions, and a pair of engaging projections which are oppositely formed on the cam lever such that they can be engaged with the engaging shoulders to separate the second teeth from the first teeth.

### BACKGROUND OF THE INVENTION

1. Field of the Invention

The present invention relates to a seat reclining device for a vehicle, and more particularly, the present invention relates to a seat reclining device for a vehicle which is configured to allow an angle of a vehicle seat back to be adjusted in forward and rearward directions for ensuring comfort of an occupant.

2. Description of the Related Art

A vehicle seat functions to ensure comfort of an occupant. The vehicle seat is provided with a seat reclining device which allows an angle of a seat back to be adjusted in forward and rearward directions in conformity with a desire of an occupant, that is, a passenger or a driver.

The seat reclining device is arranged at a region where a seat cushion frame and a seat back frame which constitute a seat are connected with each other. By manipulating a lever of the seat, projecting sideward, the seat back can be adjusted in its angle with respect to the seat cushion.

A typical seat reclining device is disclosed in Korean Patent Application No. 1999-6411 filed in the name of the present applicant.

Referring to FIGS. 2 through 4, the conventional seat reclining device 1 includes a plate holder 2 which is fastened to a rear end of a seat cushion frame and a toothed bracket 4 which is fastened by the medium of an upper bracket 3 to a lower end of a seat back frame. An operating section is interposed between the plate holder 2 and the toothed bracket 4. The toothed bracket 4 is formed with first teeth 10. A manipulating section is externally coupled to the plate holder 2. The manipulating section comprises a shaft 6, a manipulating lever 7, a lever spring 8 and a return spring 9.

The operating section comprises a pair of operating members 12, a cam lever 13 and a cam plate 14. The operating members 12 are placed in a space defined between the plate holder 2 and the toothed bracket 4. The operating members 12 are formed with second teeth 11 in a manner such that the second teeth 11 can be meshed with and separated from the first teeth 10 formed in the toothed bracket 4 so as to permit and prevent reclining of a seat back. The cam lever 13 functions to move the operating members 12 in a manner such that the second teeth 11 are meshed with the first teeth 10, and the cam plate 14 functions to move the operating members 12 in a manner such that the second teeth 11 are separated from the first teeth 10.

The cam lever 13 is formed with a pair of cams 15. The cams 15 function to push the operating members 12 in a direction where the second teeth 11 are meshed with the first teeth 10. The operating members 12 are defined with a pair of cam grooves 16 for respectively receiving the cams 15 when it is necessary to separate the second teeth 11 from the first teeth 10.

Two pairs of projecting pins 17 are formed on the operating members 12 and the cam lever 13. A pair of slots 18 are defined in the cam plate 14 in a manner such that one pair of projecting pins 17 which are respectively formed on the operating members 12 are inserted into the pair of slots 18. Also, a pair of pin holes are defined in the cam plate 14 inward of the slots 18 in a manner such that the other one pair of projecting pins 17 which are formed on the cam lever 13 are inserted into the pair of pin holes.

Describing operations of the conventional seat reclining device 1 constructed as mentioned above, initially, the lever spring 8 and return spring 9 bias, via the cam lever 13, the operating members 12 in a manner such that the second teeth 11 of the operating members 12 are meshed with the first teeth of the toothed bracket 4.

In this state, when it is necessary to recline the seat back, by pulling upward the manipulating lever 7, the shaft 6 is rotated. Then, as the cam lever 13 coupled to the shaft 6 is rotated, the pair of cams 15 are respectively received in the cam grooves 16 defined in the operating members 12. Also, as the cam plate 14 coupled to the shaft 6 is rotated with the projecting pins 17 of the operating members 12 inserted into the slots 18 of the cam plate 14, the second teeth 11 of the operating members 12 are separated from the first teeth 10 of the toothed bracket 4, whereby it is possible to recline the seat back.

However, the conventional seat reclining device 1 suffers from defects in that, due to the presence of the cam plate 14, the number of component parts is increased, and thereby, assemblability and productivity of the seat reclining device 1 are deteriorated.

Also, since the cam plate 14 comprises a thin plate and has a symmetrical arrangement, the cam plate 14 is likely to be wrongly assembled in a state wherein it is reversed. If a seat is mounted to a vehicle in this state, the seat back cannot be reclined.

Specifically, in order to operatively connect the cam plate 14 to the operating members 12 and the cam lever 13, the projecting pins 17 must be formed on the operating members 12 and the cam lever 13, and thereby, a manufacturing cost is increased. Further, due to the fact that the cam plate 14 is made of spring steel and is expensive relative to its size, an economic burden cannot but be imposed on a manufacturer.

### SUMMARY OF THE INVENTION

Accordingly, the present invention has been made in an effort to solve the problems occurring in the related art, and an object of the present invention is to provide a seat reclining device for a vehicle in which a structure of an operating section serving as a main unit is modified to decrease the number of component parts, improve assemblability and productivity, and reduce a manufacturing cost, while ensuring operational stability of the seat reclining device.

In order to achieve the above object, according to one aspect of the present invention, there is provided a seat reclining device for a vehicle, including a plate holder which is fastened to a rear end of a seat cushion frame, a toothed bracket which is fastened by the medium of an upper bracket to a lower end of a seat back frame and formed with first teeth, an operating section which is interposed between the plate holder and the toothed bracket and has a pair of operating members and a cam lever, and a manipulating section which is externally coupled to the plate holder and has a shaft, a manipulating lever, a lever spring and a return spring, the operating members being placed in a space defined between the plate holder and the toothed bracket, the operating members being formed on their outer surfaces with second teeth in a manner such that the second teeth can be meshed with and separated from the first teeth formed in the toothed bracket so as to permit and prevent reclining of a seat back, the operating members being formed on their inner surfaces with a pair of cam grooves and a pair of cam lines, the cam lever being coupled to the shaft and projectedly formed with a pair of cams which function to move the operating members in a manner such that the second teeth are meshed with the first teeth, the device comprising: means for separating the second teeth of the operating members from the first teeth of the toothed bracket, the means including a pair of arm portions which are formed by inwardly extending one ends of the inner surface portions of the operating members, a pair of engaging shoulders which are formed on free end portions of radial inner surfaces of the arm portions, and a pair of engaging projections which are oppositely formed on the cam lever in a manner such that the engaging projections can be engaged with the engaging shoulders to separate the second teeth of the operating members from the first teeth of the toothed bracket.

According to another aspect of the present invention, the means for separating the second teeth of the operating members from the first teeth of the toothed bracket includes a pair of engaging grooves which are defined in the operating members to be respectively communicated with the cam grooves, and a pair of engaging protrusions which are formed integrally with the cams of the cam lever in a manner such that the engaging protrusions can be respectively engaged into the engaging grooves to separate the second teeth of the operating members from the first teeth of the toothed bracket.

### BRIEF DESCRIPTION OF THE DRAWINGS

The above objects, and other features and advantages of the present invention will become more apparent after a reading of the following detailed description when taken in conjunction with the drawings, in which:

FIG. 1 is a partially broken-away perspective view of a vehicle seat, illustrating a seat reclining device for a vehicle according to the present invention;

FIG. 2 is a partially enlarged exploded perspective view illustrating a conventional seat reclining device for a vehicle;

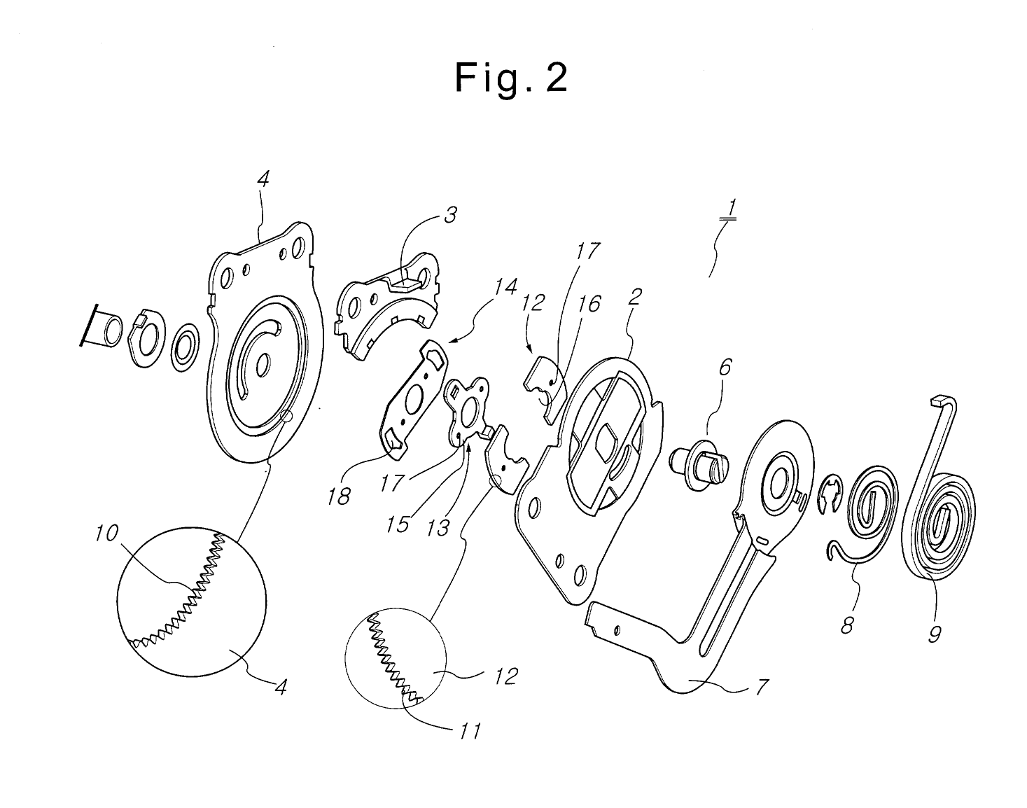

FIG. 3 is a partially broken-away cross-sectional view illustrating the conventional seat reclining device for a vehicle, which is in a recline forbidding position;

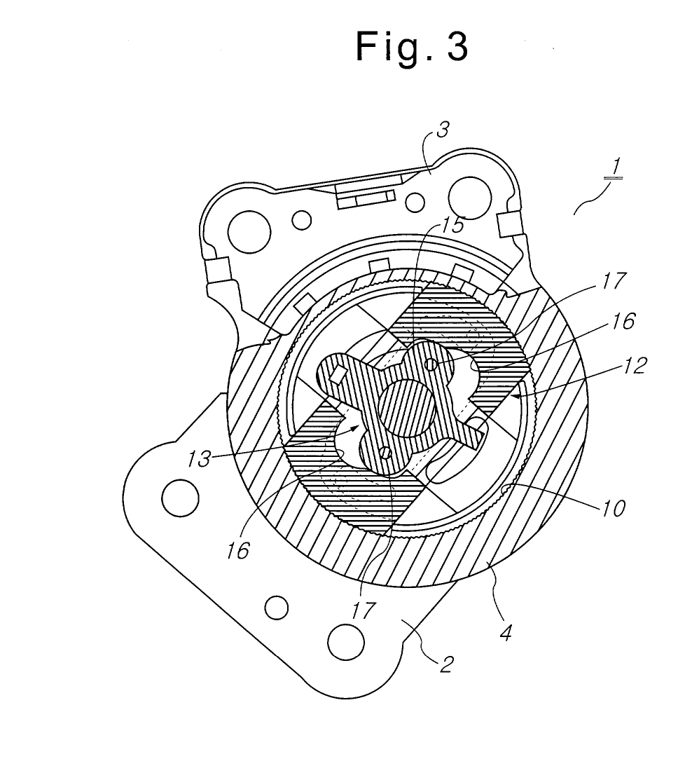

FIG. 4 is a partially broken-away cross-sectional view illustrating the conventional seat reclining device for a vehicle, which is in a recline permitting position;

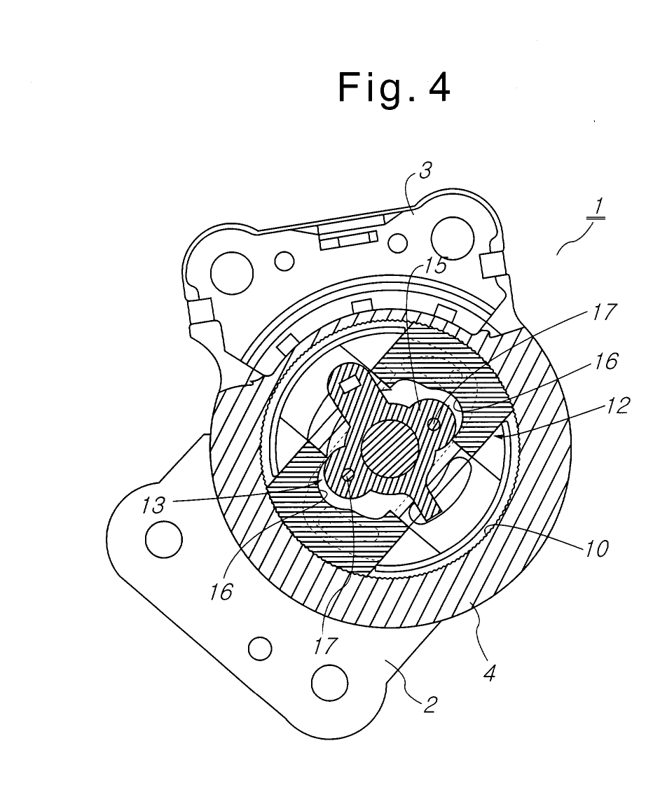

FIG. 5 is a partially broken-away cross-sectional view illustrating a seat reclining device for a vehicle in accordance with a first embodiment of the present invention, which is in a recline forbidding position;

FIG. 6 is a partially broken-away cross-sectional view illustrating the seat reclining device for a vehicle in accordance with the first embodiment of the present invention, which is in a recline permitting position;

FIG. 7 is a partially broken-away cross-sectional view illustrating a seat reclining device for a vehicle in accordance with a second embodiment of the present invention, which is in a recline forbidding position; and

FIG. 8 is a partially broken-away cross-sectional view illustrating the seat reclining device for a vehicle in accordance with the second embodiment of the present invention, which is in a recline permitting position.

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

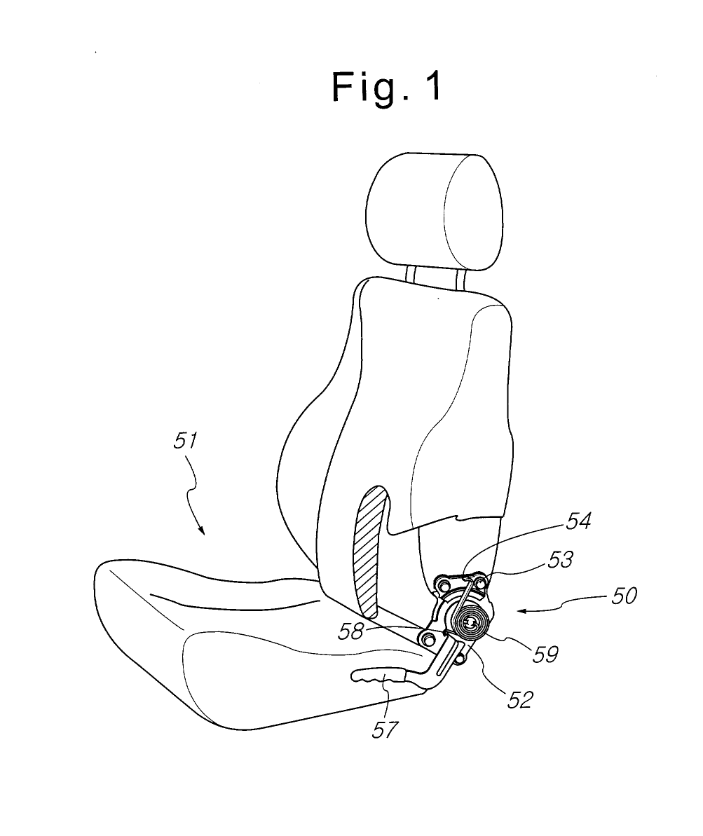

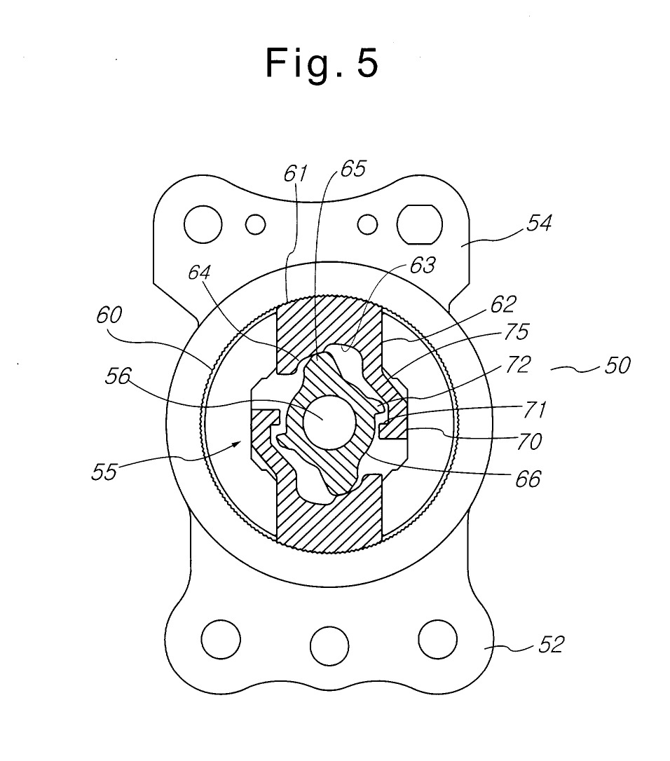

Referring to FIGS. 1, 5 and 6, a seat reclining device 50 for a vehicle, in accordance with a first embodiment of the present invention, includes a plate holder 52, a toothed bracket 54, an operating section 55, and a manipulating section. The plate holder 52 is fastened to a rear end of a seat cushion frame of a vehicle seat 51. The toothed bracket 54 is fastened by the medium of an upper bracket 53 to a lower end of a seat back frame and formed with first teeth 60. The operating section 55 is interposed between the plate holder 52 and the toothed bracket 54. The manipulating section is externally coupled to the plate holder 52 and has a shaft 56, a manipulating lever 57, a lever spring 58 and a return spring 59.

In the present invention, differently from the conventional art, a cam plate is omitted among component parts constituting the operating section 55, and operating members and a cam lever are modified in their structures in a manner such that the operating members can be pushed and pulled only by the medium of the cam lever, whereby, as the number of assembling processes for the seat reclining device 50 is decreased and a fabricating procedure for each component part is simplified, it is possible to improve productivity and reduce a manufacturing cost.

The operating section 55 has a pair of operating members 62 and a cam lever 66. The operating members 62 are placed in a space defined between the plate holder 52 and the toothed bracket 54. The operating members 62 are formed on their outer surfaces with second teeth 61 in a manner such that the second teeth 61 can be meshed with and separated from the first teeth 60 formed in the toothed bracket 54 so as to permit and prevent reclining of a seat back. Further, the operating members 62 are formed on their inner surfaces with a pair of cam grooves 63 and a pair of cam lines 64. The cam lever 66 is coupled to the shaft 56 and projectedly formed with a pair of cams 65 which function to move the operating members 62 in a manner such that the second teeth 61 are meshed with the first teeth 60.

A pair of arm portions 70 are formed by inwardly extending one ends of the inner surface portions of the operating members 62. A pair of engaging shoulders 71 are formed on free end portions of radial inner surfaces of the arm portions 70. A pair of engaging projections 72 are integrally formed on the cam lever 66 in a manner such that they are opposite to each other and can be engaged with the engaging shoulders 71. The engaging shoulders 71 can be radially pulled inward by the engaging projections 72 to separate the second teeth 61 of the operating members 62 from the first teeth 60 of the toothed bracket 54.

In this preferred embodiment of the present invention, each arm portion 70 has an inclined portion 75 which is inclined outward of the cam groove 63 in a manner such that rotation of the engaging projections 72 is not obstructed by the arm portion 70 upon operating the cam lever 66.

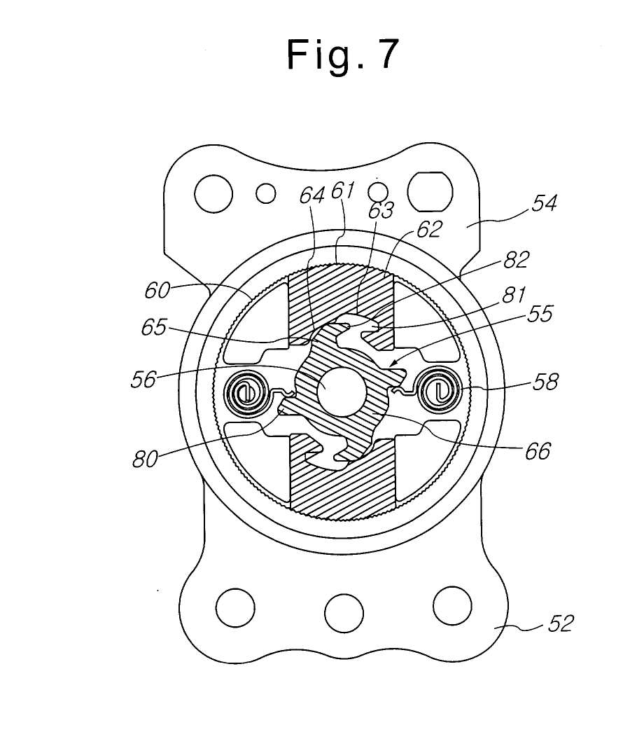

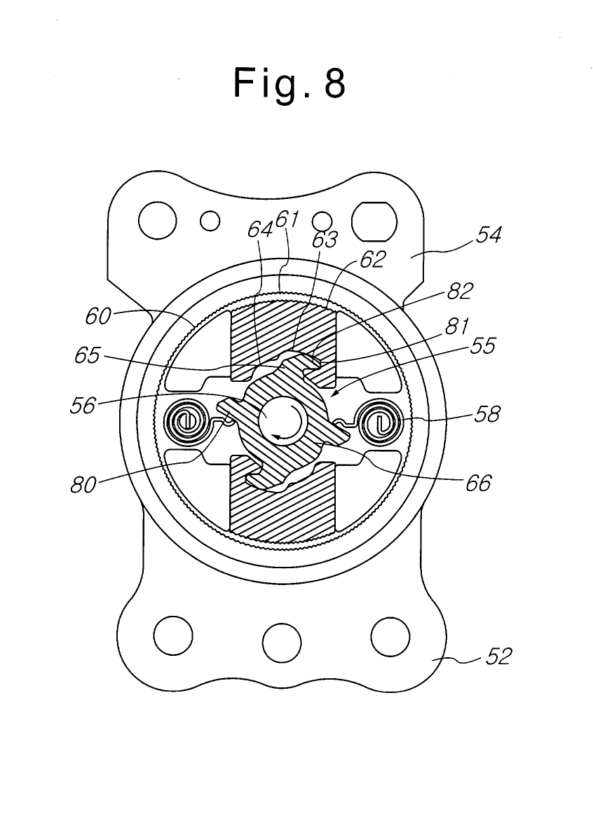

Referring to FIGS. 7 and 8, there is shown a seat reclining device for a vehicle in accordance with a second embodiment of the present invention. This second embodiment can be applied to the case that a pair of lever springs 58 for returning a cam lever 66 to its original position are placed between a plate holder 52 and a toothed bracket 54 and one ends of inner surface portions of operating members 62 cannot be inwardly extended due to the presence of spring pin portions 80 which project outward at both sides of the cam lever 66 to support the lever springs 58. In this second embodiment of the present invention, a pair of engaging grooves 81 are defined in the operating members 62 in such a way as to be respectively communicated with cam grooves 63. Also, a pair of engaging protrusions 82 are formed integrally with cams 65 of the cam lever 66 in a manner such that the engaging protrusions 82 can be respectively engaged into the engaging grooves 81 to separate second teeth 61 of the operating members 62 from first teeth 60 of the toothed bracket 54.

Hereafter, operations of the seat reclining device for a vehicle according to the present invention, constructed as mentioned above, will be described.

In an initial state, due to the fact that the second teeth 61 of the operating members 62 interposed between the plate holder 52 and the toothed bracket 54 are meshed with the first teeth 60 formed in the toothed bracket 54, the toothed bracket 54 is prevented from being rotated about the shaft 56.

In other words, in the initial state, the manipulating lever 57 is maintained in its original state by the lever spring 58 and return spring 59. Further, the pair of cams 65 of the cam lever 66, which is connected to the manipulating lever 57 to control movement of the operating members 62, are respectively brought into contact with the cam lines 64 of the operating members 62 and bias the operating members 62 radially outward.

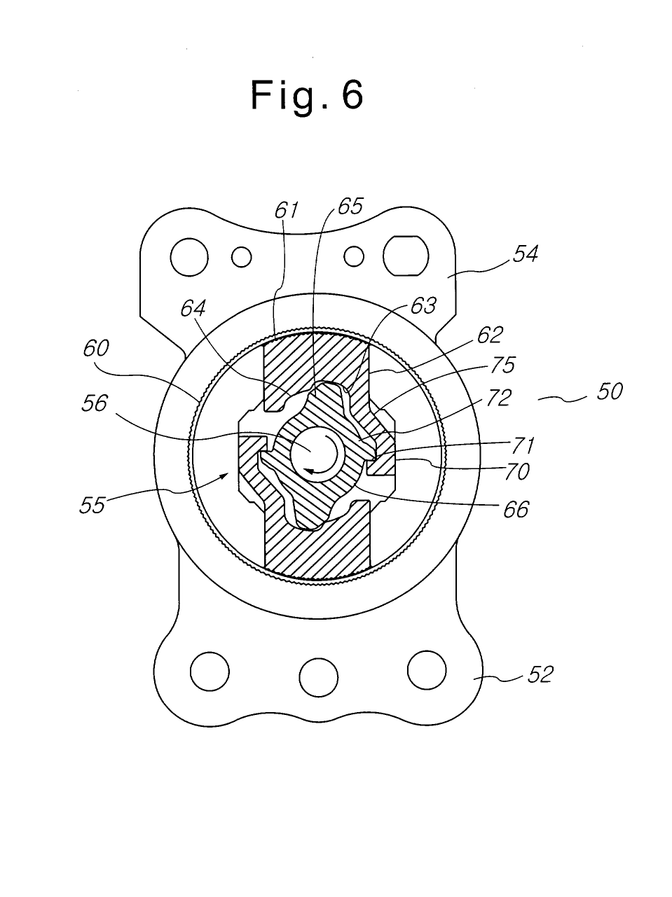

When it is necessary to recline the seat back of the vehicle seat 51, by pulling the manipulating lever 57 upward, the shaft 56 which is joined to the manipulating lever 57 is rotated in a direction shown by the arrow (see FIG. 6), and the cam lever 66 which is coupled with the shaft 56 is also rotated in the same direction, by which the cams 65 of the cam lever 66 are respectively inserted into the cam grooves 63.

At this time, as the cam lever 66 is rotated in a state where the engaging projections 72 formed on the cam lever 66 are respectively engaged with the engaging shoulders 71 formed on the arm portions 70 of the operating members 62, the cam lever 66 pulls the operating members 62 radially inward in a manner such that the second teeth 61 of the operating members 62 are separated from the first teeth 60 of the toothed bracket 54, whereby it is possible to recline the seat back of the vehicle seat 51.

If the seat back of the vehicle seat 51 is reclined to a desired angular position, by freeing the manipulating lever 57 pulled upward, the lever spring 58 and return spring 59 which are in a compressed state are returned to a normal state, and the manipulating lever 57 resumes its original position.

Then, as the shaft 56 and the cam lever 66 coupled with the shaft 56 are rotated in a reverse direction, the cams 65 held inserted into the cam grooves 63 are moved toward the cam lines 64 to bias the operating members 62 radially outward again.

As a consequence, the second teeth 61 of the operating members 62 interposed between the plate holder 52 and the toothed bracket 54 are meshed with the first teeth 60 of the toothed bracket 54, and the seat back of the vehicle seat 51 can be reliably maintained in a reclined state.

In the present invention, since a cam plate is not needed, it is not necessary to form projecting pins on the operating members and cam lever to allow them to be operatively connected to the cam plate. As a consequence, the operating members and cam lever can be easily fabricated, the likelihood of the seat reclining device to be wrongly assembled is decreased and thereby assemblability is improved, and operational reliability of the seat reclining device after assembly is ensured.

As apparent from the above description, the seat reclining device for a vehicle according to the present invention provides advantages as described below. Since a cam plate is removed among component parts constituting an operating section which serves as a main unit of the seat reclining device, in a manner such that operating members can be pushed and pulled by a cam lever, the number of component parts is decreased to improve assemblability and productivity, operational stability of the seat reclining device is ensured, and a manufacturing cost is reduced.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A seat reclining device for a vehicle, including a plate holder which is fastened to a rear end of a seat cushion frame, a toothed bracket which is fastened by the medium of an upper bracket to a lower end of a seat back frame and formed with first teeth, an operating section which is interposed between the plate holder and the toothed bracket and has a pair of operating members and a cam lever, and a manipulating section which is externally coupled to the plate holder and has a shaft, a manipulating lever, a lever spring and a return spring, the operating members being placed in a space defined between the plate holder and the toothed bracket, the operating members being formed on their outer surfaces with second teeth in a manner such that the second teeth can be meshed with and separated from the first teeth formed in the toothed bracket so as to permit and prevent reclining of a seat back, the operating members being formed on their inner surfaces with a pair of cam grooves and a pair of cam lines, the cam lever being coupled to the shaft and projectedly formed with a pair of cams which function to move the operating members in a manner such that the second teeth are meshed with the first teeth, the device comprising:
means for separating the second teeth of the operating members from the first teeth of the toothed bracket, the means including a pair of arm portions which are formed by inwardly extending one ends of the inner surface portions of the operating members, a pair of engaging shoulders which are formed on free end portions of radial inner surfaces of the arm portions, and a pair of engaging projections which are oppositely formed on the cam lever in a manner such that the engaging projections can be engaged with the engaging shoulders to separate the second teeth of the operating members from the first teeth of the toothed bracket.

2. The seat reclining device as set forth in claim 1, wherein the means for separating the second teeth of the operating members from the first teeth of the toothed bracket includes a pair of engaging grooves which are defined in the operating members to be respectively communicated with the cam grooves, and a pair of engaging protrusions which are formed integrally with the cams of the cam lever in a manner such that the engaging protrusions can be respectively engaged into the engaging grooves to separate the second teeth of the operating members from the first teeth of the toothed bracket.
